(19) United States
(12) Patent Application Publication
(10) Pub. No.: US 2015/0037558 A1
(43) Pub. Date: Feb. 5, 2015

(54) METHOD FOR MANUFACTURING A MAGNETOCALORIC ELEMENT, AND MAGNETOCALORIC ELEMENT THUS OBTAINED

(71) Applicant: ERASTEEL, Paris (FR)

(72) Inventors: Alexandra Dubrez, Uppsala (SE); Peter Vikner, Paris (FR); Charlotte Mayer, Paris (FR); Michel Pierronnet, Sermoise Sur Loire (FR)

(21) Appl. No.: 14/385,481

(22) PCT Filed: Mar. 18, 2013
(86) PCT No.: PCT/EP2013/055558

§ 371 Date: Sep. 15, 2014

(30) Foreign Application Priority Data
Mar. 16, 2012 (FR) 12 52387

(51) Int. Cl. H01F 1/01; B22F 1/00; B22F 1/02; H01F 41/02

(52) U.S. Cl. CPC H01F 1/015; H01F 41/0266; B22F 1/0085; B22F 1/02; B29C 2035/0827
USPC 428/220; 252/62.54; 264/429; 264/211.12; 264/328.17; 264/299

(57) ABSTRACT

A method for manufacturing a magnetocaloric element including the following steps:
a powder of a magnetocaloric alloy with composition:

La₁₋ₓ(Ce,Pr)ₓ((Fe_{1-z-v}Mn_{z}Coᵥ)_{1-y}Si_{y})_{w}Xₙ

is prepared, wherein:
X is one or several elements selected from H, C, N and B;
x=0 to 0.5;
y=0.05 to 0.2;
z=0 to 0.15;
v=0 to 0.15;
w=12 to 16;
n=0 to 3.5;
the remainder being impurities, with a maximum content of 4% by weight, preferably a maximum content of 2% by weight, of rare earths other than La, Ce and Pr, and a maximum content of 2% by weight, for the other impurities, the preparation of the powder including the following steps:
a liquid alloy (4) is elaborated;
it is solidified in the form of a powder of substantially spherical particles (14) with an average diameter comprised between 10 and 100 μm by atomization of a jet (8) by means of an inert gas;
said powder (14) is heat-treated in order to give it at least 70% by weight of a structure of the NaZn₁₃ type by heating up to a temperature from 900 to 1,200° C.;
optionally, a hydridration and/or nitridation and/or carbidation and/or carbonitridation treatment is carried out for giving n its definitive value;
said powder (14) is dispersed in a matrix formed by one or several organic binders for forming a mixture including from 40 to 80% by volume of powder;
said mixture is shaped.

The invention relates to magnetocaloric materials, and more particularly to those which may be used as magnetic coolants, at temperatures from about −30 to +50° C., therefore surrounding room temperature, under the action of moderate magnetic fields produced by permanent magnets.

Today, a large portion of the worldwide consumption of energy is dedicated to refrigeration and air conditioning installations (25% of the domestic electricity market in the United States). Magnetic refrigeration is one of the novel techniques which aim at being substituted for conventional cold production techniques by gas compression, since they have the advantage of not using any CFCs or HCFCs and of having a better energy yield (of the order of 30% greater). It consists of using a particular type of magnetic material, a so-called magnetocaloric material, which has a variation of temperature when it is subject to the action of an external magnetic field. A temperature difference of large amplitude is then obtained in the surroundings of the material when the material undergoes successive magnetization/demagnetization cycles.

This magnetocaloric effect is notably observed for ferromagnetic materials in the vicinity of their Curie temperature T_{C}. Gd is the reference magnetocaloric material which may be used for refrigeration applications around room temperature, its isothermal magnetic entropy variation ΔSₘ being of −10 J/kg·K and its adiabatic temperature variation ΔT_{ad} being of 12 K in a magnetic field of 5 T. The magnetocaloric effect has been particularly studied in alloys based on rare earths and/or transition metals, because of their ferromagnetism and of their high magnetic moment densities. Among them, the alloys La(Fe₁₋ₓSiₓ)₁₃ prove to be particularly of interest, since they have high magnetocaloric properties and a lesser raw material cost than that of alloys based on Gd. Further, Gd is a relatively rare material.

The alloys La(Fe₁₋ₓSiₓ)₁₃ have a structure of the NaZn₁₃ type. Their T_{C} may be modified by introducing another transition metal which will be partially substituted for Fe, such as Co for increasing it and Mn for reducing it. This will also have the consequences:
degradation of the magnetocaloric properties (unfavorable for the relevant application);
and reduction of the thermal hysteresis of the material (favorable to the relevant application).

It is also possible to adjust the magnetostrictive properties and the T_{C} of the material by inserting elements such as H, C, N or B into the crystallographic lattice of space group Fm-3c. This insertion has the effect of increasing T_{C} by increasing the lattice parameter a and the Fe—Fe distances. The magnetocaloric properties are themselves reduced but to a lesser extent than by the substitution of Fe. It is also possible to adjust T_{C} by substituting another rare earth for La, mainly Ce and Pr which reduce the lattice parameter a and therefore T_{C}, but maintain or even increase the magnetocaloric properties.

The synthesis of these materials is conventionally achieved by melting and solidifying a stoichiometric mixture of their components, followed by an extended annealing step at 900-1,200° C. in order to cause disappearance of the secondary phases and obtain the targeted NaZn₁₃ structure. Optimally, a fast solidification method should be applied, in order to avoid a too significant segregation of the phases which would lead to excessive annealing durations for the productivity of the method.

This fast solidification may be achieved by projecting the liquid alloy on a cooled rotating surface, in order to obtain for example an alloy ribbon which is then milled in order to form a powder. Document U.S. Pat. No. 7,186,303, for example describes such a method.

Another fast solidification method consists of atomizing a liquid alloy jet leaving a distributor by projecting a high velocity gas on it. A powder is thus directly obtained, for which the particles have an average diameter from 10 to about 100 μm, and which may directly be used for the subsequent steps for manufacturing a material. Document EP-A-1 867 744 mentions such a method.

Document US-A-20100047527 describes a method for obtaining magnetocaloric components by reactive sintering. Reactive sintering consists of shaping and sintering a mixture of powders of different compositions (called precursors). The document also describes the method for obtaining the precursors. The primary precursors FeLa and LaY are prepared from a massive state, for example obtained by casting metal ribbons on a wheel, and are then milled for obtaining fine powders and with a homogenous distribution. After that, it is useful if one of the precursors is hydrided in order to facilitate milling and to reduce the amount of undesirable elements in the precursors. Both powders of precursors, preferentially one of which is hydrided, are then mixed and milled again in order to obtain a homogenous mixture (secondary precursor) with a powder grain size of less than 10 microns (2.7 microns in the described example).

Gas atomization gives the possibility of omitting all these steps and of directly obtaining a single precursor powder, the composition of which is very well controlled. The powder may be sintered or activated and/or hydrogenated for obtaining a magnetocaloric material.

Another document JP-A-2007 031831 describes a method for obtaining a magnetocaloric powder by milling oxides. Powders of rare earth, Si and Fe oxides are mixed with a reducing agent and a disaggregation accelerator, and heated under an inert atmosphere between 1,000 and 1,250° C. for a rather long time in order to ensure reduction and atomic diffusion. The powder is then cooled and treated under hydrogen between 100 and 500° C. Finally, it is immersed in water in order to separate the reducing agents and disaggregation agents of the powder. This method is clearly more unwieldy to apply than atomization followed by annealing, and does not give the possibility of obtaining similar amounts of powders.

The main drawback of the known methods is, however, the need for producing sintering of the powder in order to put it in the form of a magnetocaloric element. The material is thus exposed to a risk of oxidation, elements of complex shapes cannot be easily made, and the sintering temperatures will induce disinsertion of the elements (H or N) inserted beforehand in the powder.

The object of the invention is to propose a method for manufacturing a composite magnetocaloric material which provides, at a competitive cost and in an industrially applicable way, magnetocaloric materials with a structure of the NaZn₁₃ type with high performances, having a T_{C} range located between −30 and +50° C. and high magnetocaloric properties, with low thermal hysteresis, which may easily be shaped and no need for performing sintering during this shaping.

For this purpose, the object of the invention is a method for manufacturing a magnetocaloric element, characterized in that it includes the following steps:
at least one powder of a magnetocaloric alloy is prepared with a composition:

La₁₋ₓ(Ce,Pr)ₓ((Fe_{1-z-v}Mn_{z}Coᵥ)_{1-y}Si_{y})_{w}Xₙ

where:
X is one or several elements selected from H, C, N and B;
x=0 to 0.5, preferably 0.25 to 0.5;
y=0.05 to 0.2;
z=0 to 0.15;
v=0 to 0.15;
w=12 to 1;
n=0 to 3.5, preferably 1 to 3.5;

the remainder being impurities resulting from the elaboration, with a maximum content of 4% by weight, preferably at most 2% by weight, of rare earths other than La, Ce and Pr, and a maximum content of 2% by weight for the other impurities, the preparation of the powder itself including the following steps:
a liquid alloy is elaborated in a crucible;
said liquid alloy is solidified as a powder of substantially spherical particles with an average diameter comprised between 10 and 100 μm by atomization of a jet of said liquid alloy by means of an inert gas;
optionally, said powder is heat-treated at a temperature comprised between 100 and 500° C. for at least 1 min in a non-oxidizing atmosphere in order to remove the compounds adsorbed by the powder;
said powder is heat-treated so as to give it at least 70% by weight of a structure phase of the NaZn₁₃ type, by heating under an inert or reducing atmosphere or in vacuo up to a temperature from 900 to 1,200° C., preferably from 1,000 to 1,200° C.;
optionally, a hydridation and/or nitridation and/or carbidation and/or carbonitridation treatment for giving n its definitive value;
said powder is dispersed in a matrix formed by one or several organic binders in order to form a mixture including from 40 to 80% by volume of powder;
said mixture is shaped;
and optionally solidification of the matrix is carried out.

The heat-treatment of the powder giving it a structure of the NaZn₁₃ type may include a step for heating the powder at a rate of 1 to 200° C. min up to the treatment temperature.

The solidification of the matrix may be carried out by heating between 20 and 300° C. and/or by projecting UV radiations.

Before the shaping, the mixture formed by the powder and the binders may be milled or transformed into granules.

It is possible to mix with the matrix at least two different powders, for which the higher and lower Curie temperatures differ by at most 80° C.

The binder may include at least one polymer selected from polyethylene, ethylene vinyl acetate, polypropylene, polystyrene, polycarbonate, epoxy resins, polyurethane resins.

The shaping of the mixture may be achieved by transformation under a pressure from 1.5 to 3000 MPa at a temperature from 20 to 300° C., for example:

The shaping of the mixture may be achieved by compression in a mold.

The shaping of the mixture may be achieved by injection into a mold.

The shaping of the mixture may be achieved by extrusion.

The object of the invention is also a magnetocaloric element, characterized in that it is obtained with the previous method.

Its thickness is at least locally comprised between 0.2 and 2 mm.

As this will have been understood, the invention is based on the association of several features related to the manufacturing method, strictly speaking, of the material and to its composition.

Firstly, it is the fast solidification by gas atomization which is exclusively selected for manufacturing the powder from which the magnetocaloric material will be obtained.

This powder then undergoes annealing between 900 and 1,200° C., preferably between 1,000° C. and 1,200° C., under an inert atmosphere in order to form the magnetocaloric phase of the NaZn₁₃ type in optimal proportions, i.e. of at least 70% by weight. Successive heat-treatments under an atmosphere containing hydrogen or nitrogen or under a carbonaceous atmosphere are practiced, if it is desired to insert one or several of the elements H, N and C into the phase of the NaZn₁₃ type.

Finally, the shaping of the magnetocaloric material occurs for example by transformation under a pressure from 1.5 to 3,000 MPa at a temperature from 20 to 300° C. of a mixture of said metal powder and of organic components acting as binders for the particles of said powder. For this purpose, it is notably possible to use pressurized molding, injection into a mold, or extrusion. Other shaping methods which are functionally equivalent may be contemplated.

The material preferably integrates a relatively large amount of Ce substituting it partially for La. Ce preferably represents between 25 and 50% of the atomic percentage of rare earths. In this way, the manufacturing cost may be reduced, the La—Ce mixture which may be used for this purpose being substantially less expensive than La alone, which is an ultimate product of a separation of materials containing rare earths (“Mischmetall”). The magnetocaloric properties are also improved by this introduction of Ce, but at the cost of lowering T_{C} which may be compensated by other adjustments of the composition of the material.

Pr may also be used in addition to or instead of Ce as a substituent for La, and in similar proportions, with the drawback of a normally higher cost than Ce.

Substitution of La with other rare earths such as Ce and Pr would be in principle possible. However, beyond Pr in the Periodic Table, the lanthanides notably have a smaller atomic radius than La. This will limit the possibility of substituting it with these atoms in the NaZn₁₃ structure and will cause formation of phases other than those of the NaZn₁₃ type. This is why the content of rare earths other than La, Ce and Pr, should not exceed 4%, preferably should not exceed 2%.

In order to increase T_{C}, the material may undergo a hydridation as extensive as possible, preferably total hydridation, in order to shift its T_{C} towards room temperature. Other elements in this respect, functionally equivalent with H (i.e. C, N, B) may be added to it or replace it for this purpose.

T_{C} may also be complementarily adjusted by partially substituting Mn and/or Co for Fe. Substitution of Fe with Mn reduces T_{C} while that with Co increases it.

A low proportion of ferrite α-Fe(Si) or Fe(Co,Si), or Fe(Mn,Si)) is inevitably present in the activated powder making up the material. The presence of this phase should, however, be limited as far as possible, in order to obtain a maximum proportion of the NaZn₁₃ type phase (at least 70% by weight). Except for that, the ferrite α, which has a clearly greater T_{C} at the temperatures targeted for this application, does not have any detrimental effect on the magnetocaloric properties.

The invention will be better understood upon reading the description as follows, given with reference to the following appended figures:

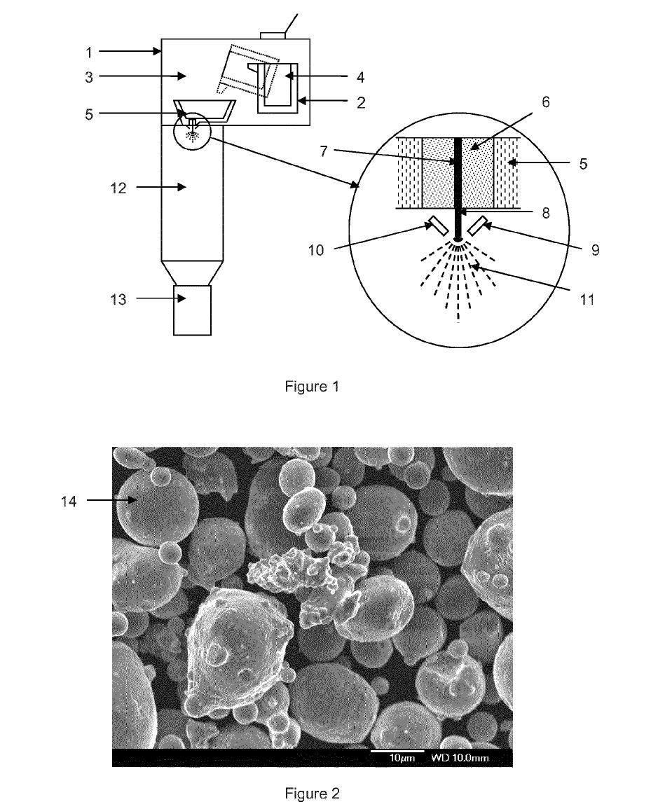

FIG. 1 which schematically shows in a longitudinal section an example of an installation for melting and solidifying as a powder, the alloy being used for manufacturing the materials according to the invention, the atomization area located under the distributor being separately shown at a larger scale;

FIG. 2 which shows a secondary electron observation achieved with the scanning electron microscope, of a group of particles of an example of said powder (powder A);

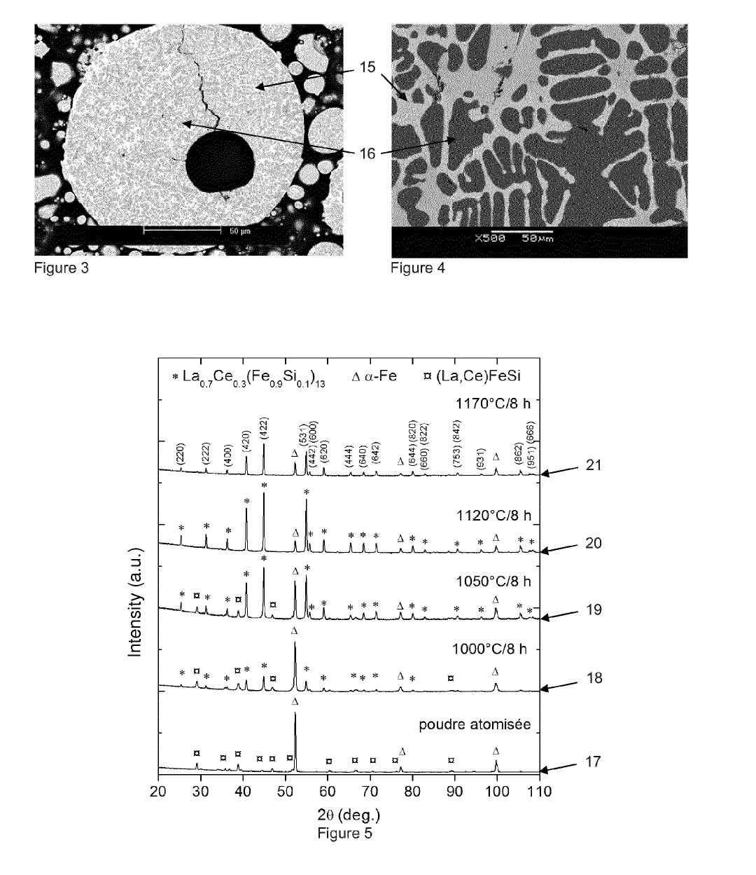

FIGS. 3 and 4 which show back-scattered electron images obtained with the scanning electron microscope, of a material with a composition according to the invention after atomization according to the method described in the invention (FIG. 3) and after conventional casting as an ingot (FIG. 4);

FIG. 5 which shows x-ray diffractograms of a powder manufactured according to the invention after atomization and after various annealing conditions (powder B);

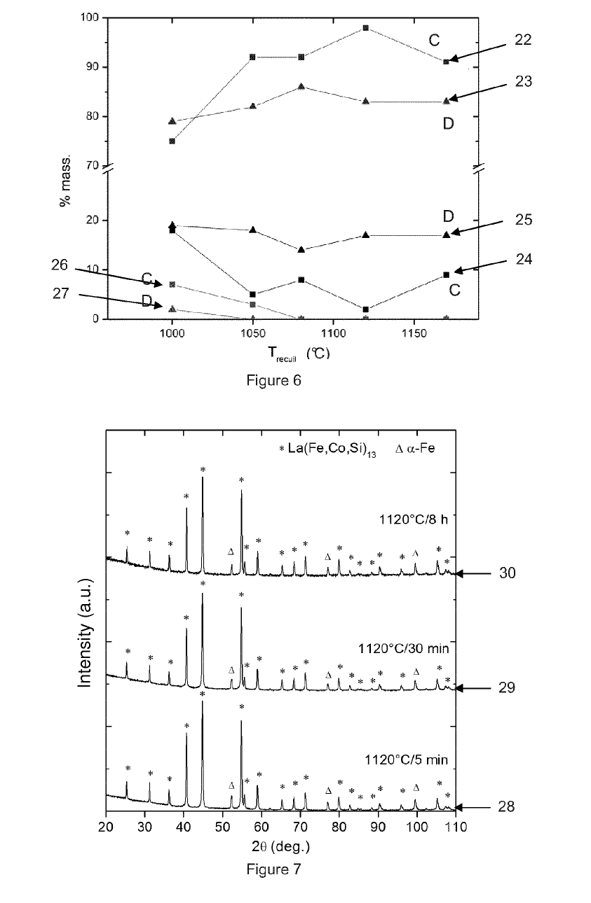

FIG. 6 which shows the time-dependent change in the mass proportions of the phases of the NaZn₁₃, a ferrite type and of the LaFeSi type versus the annealing temperature, in powders manufactured according to the invention (powders C and D);

FIG. 7 which shows the x-ray diffractograms of a powder manufactured according to the invention (powder C) after atomization and then after annealing at 1,120° C. for various durations;

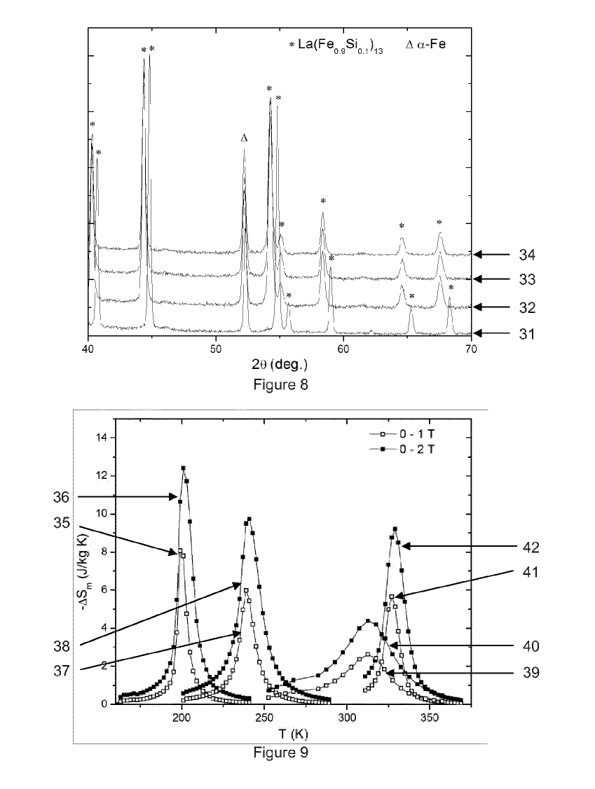

FIG. 8 which shows the x-ray diffractograms of a powder (powder D) manufactured according to the invention, before and after hydrogenation under various conditions;

FIG. 9 which shows the time-dependent change in the variation of magnetic entropy according to the temperature of the atomized and annealed powders according to the invention in the La—Fe—Si system (powder D), in which various proportions of Co have been substituted for Fe (C and E powders), or hydrogen has been inserted (powder D is totally hydrogenated) into the phase of the NaZn₁₃ type;

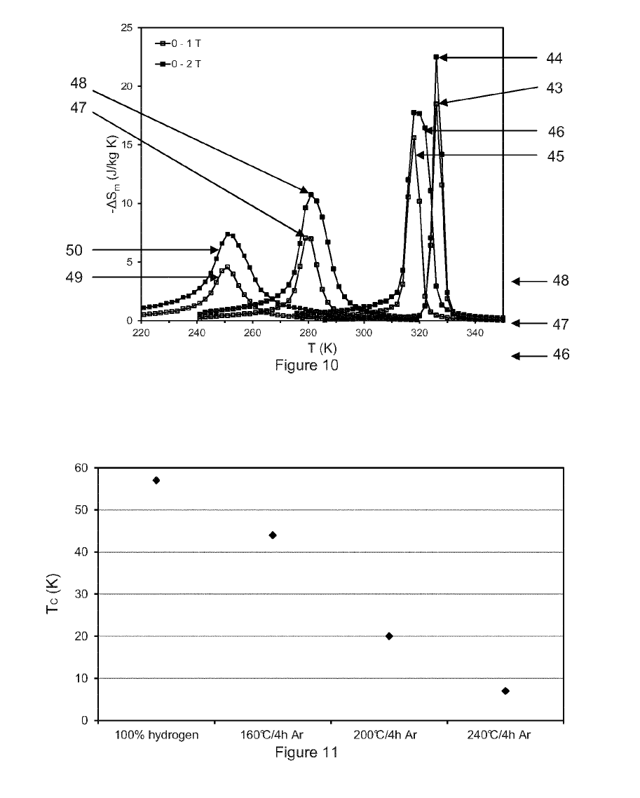

FIG. 10 which shows the time-dependent change in the variation of magnetic entropy according to the temperature of the atomized and annealed and totally hydrogenated powders according to the invention, in the La—Ce—Fe—Si—H system, wherein various proportions of Mn have been substituted for Fe (powders B, F, G and H);

FIG. 11 which shows the time-dependent change in the Curie temperature T_{C} of an atomized, annealed and totally hydrogenated powder according to the invention (powder D) after various dehydrogenation treatments;

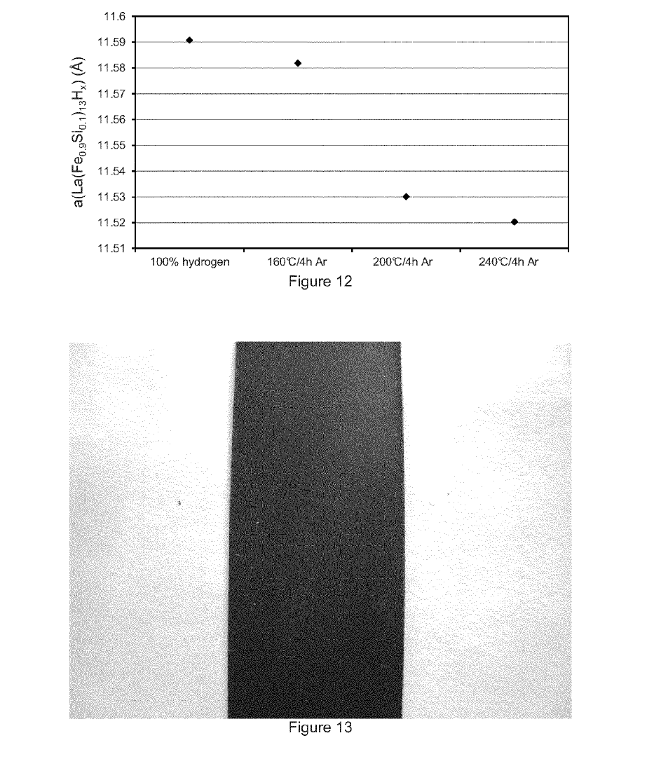

FIG. 12 which shows the time-dependent change of the lattice parameter a (in Å) of the magnetocaloric phase of an atomized, annealed and totally hydrogenated powder (powder D) after different dehydrogenation treatments;

FIG. 13 which shows an extruded plate manufactured according to the invention;

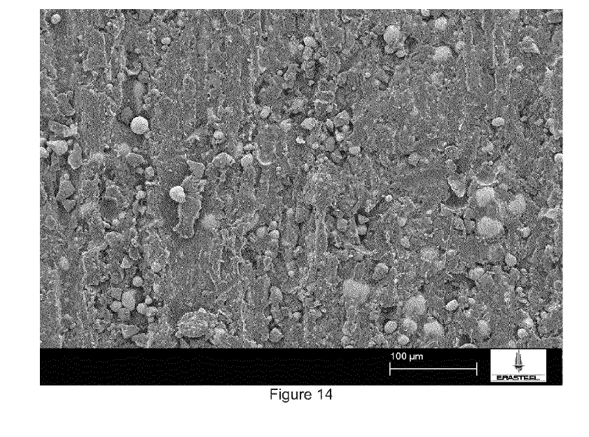

FIG. 14 which is a micrograph showing the incorporation of magnetocaloric powders into an organic matrix.

The first step of the method for manufacturing the material according to the invention is melting the constituents of the alloy intended to form the material according to the invention. The latter should have, as a final general formula, once all the treatments which may affect its composition have been carried out:

La₁₋ₓ(Ce,Pr)ₓ((Fe_{1-z-v}Mn_{z}Coᵥ)_{1-y}Si_{y})_{w}Xₙ

wherein:
X is one or several elements selected from H, C, N and B;
x=0 to 0.5, preferably 0.25 to 0.5;
y=0.05 to 0.2;
z=0 to 0.15;
v=0 to 0.15;
w=12 to 16;
n=0 to 3.5, preferably 1 to 3.5.

It should be understood that other rare earths such as La, Ce and Pr may optionally be present as impurities, taking into account the fact that rare earths cannot be easily separated from each other. It is possible to thereby tolerate up to 4% by weight, better up to 2% by weight, of rare earths other than La, Ce and Pr in the final alloy.

Impurities usually present in the raw materials used for introducing the other elements may also be present in the final alloy. All in all, up to 2% by weight of impurities are tolerated in the final alloy (except for rare earths other than La, Ce and Pr) in addition to the elements explicitly mentioned in the formula above.

At the stage of the end of the melting and elaboration of the alloy in the liquid state, the liquid metal should already have this composition, except possibly regarding n. Indeed, if in the final alloy, n is not zero, it may, however, be equal to 0 at the end of the atomization if neither B nor C are used. If X is H and/or N, these elements are, as this will be seen, added to the solidified alloy via a gas route, at a subsequent stage of the method, and may be used together or separately. It is not desirable to insert them in the material before the formation of the phase of the NaZn₁₃ type, therefore before the annealing phase of the atomized powders. Conversely, if X is B (exclusively, or together with at least one of H, N or C), this element should be present as soon as the raw materials are melted if it is intended to find it again in the final product. As regards C, it may be added, optionally in solid form with the molten materials, or via a gas route into the solidified alloy, both of these methods may be used together. Therefore, if the final alloy has to contain C, n may nevertheless be zero at the end of the elaboration (with impurities which may notably comprise a little C and N).

All the melting and solidification process is, as illustrated in FIG. 1, carried out in a confined chamber 1, the atmosphere of which may be controlled as this will be explained.

The massive raw materials are melted in a heated crucible 2, for example by induction, to a temperature comprised between 1,400 and 1,800° C., preferably between 1,500 and 1,700° C. The minimum of 1,400° C. gives the possibility of ensuring that the melting of the constituents has actually been complete. The atmosphere surrounding the liquid metal bath is formed by an inert gas, preferably argon, and the pressure is at least equal to atmospheric pressure, preferably greater than the latter, in order to limit the leaving of the elements which, under reduced pressure would be able to evaporate, notably rare earths. This limitation of the evaporation of the elements is also why a maximum temperature of 1,800° C. is imposed. Below 1,500° C., at least for alloys with a relatively high melting point, there is a risk of causing setting of the liquid metal in the orifice of the casting nozzle, for which will be seen to have a small diameter. Beyond 1,700° C., the risks of reactions between the liquid metal and the refractories of the crucible are increased, which lead to the introduction of undesired impurities into the alloy (Al, Mg for example which reduce the magnetocaloric performances of the alloy).

Rare earths like La, Ce and Pr are well known for being easily oxidized, hence the importance of carrying out the whole melting and solidification process in an oxygen-free atmosphere 3 as far as possible.

The liquid metal 4, once its composition and its temperature are adjusted, is poured into a distributor 5. This distributor 5 has its bottom equipped with at least one nozzle 6, the outlet orifice 7 of which has a diameter of the order of 2 to 10 mm. The liquid metal jet 8 leaving the orifice 7 of the nozzle 6 is atomized by jets of an inert gas (preferably argon) against the liquid metal, leaving one or several nozzles 9, 10, and which is at a pressure, for example, of 8 to 80 bars before its outflow. Typically the atomization gas has an oxygen content of at most 0.02% by weight for avoiding oxidation of the metal.

The object of this atomization of the jet 8 into fine droplets 11, and which requires adjustment of the installation accordingly (according to the customary expertise of one skilled in the art since the solidification method by atomization is not per se a novelty), is to form, from these droplets which solidify, substantially spherical particles with an average diameter comprised between 10 and 100 μm in which the segregation of the phases at equilibrium is minimized. Stronger segregation would induce very long annealing times and be unsuitable for the case of industrial production.

A greater particle size would make it difficult to obtain narrow sections of the shaped magnetocaloric element required for good heat exchanges during the use of the element. A lower particle size may only be obtained by reducing the flow rate of the liquid metal jet 8 leaving the nozzle 6, down to an exaggerated low value which would pose operating problems (high risks of blocking the orifice 7 by the setting of the liquid metal 4).

The solidified particles are collected in the cooled lower portion 13 of the atomization tower 12.

And then the heat-treatment and the shaping of the material are achieved from the powder solidified by atomization.

Preferentially, one begins by maintaining the powder at a temperature from 100 to 500° C. for a period of at least 1 min, and which may attain several hours, in a non-oxidizing atmosphere. For this latter feature, the treatment may be carried out in vacuo, or in an inert or reducing atmosphere. The purpose of this treatment is to remove the compounds which may have been adsorbed by the powder, notably humidity, without altering the composition of the powder.

Next the heat-treatment of the powder takes place followed by the optional hydridation or nitridation which will give the powder its structure of the NaZn₁₃ type, and optionally its definitive composition before shaping the material.

The powder is heated under an inert or reducing atmosphere or in vacuo, preferably at a rate of 1 to 200° C. min, up to a temperature from 1,000 to 1,200° C., preferably 1,050 to 1,170° C., optimally from 1,080 to 1,150° C. depending on the composition of the material.

Too fast heating risks only causing reduced formation of the NaZn₁₃ phase, this formation not being instantaneous. Too slow heating compromises the productivity of the method.

The duration of this maintaining of temperature is to be selected by a series of routine experiments notably depending on the amount of powder treated and on the arrangement of the particles, since this duration should be such that the whole of the material is properly treated. This may last without any qualitative drawbacks for up to 24 hours or even more. It may be noted that this heat-treatment makes the powder clearly less sensitive to oxidation than the original powder. Indeed, during this treatment, the whole of the rare earths and a large portion of the transition metals are alloyed and thus become more resistant to oxidation.

Next, hydridation of the powder is optionally achieved. For this purpose, it is for example possible to carry out a heat-treatment at 100-500° C. for 1 to 500 mins in a hydrogenated atmosphere at a hydrogen partial pressure from 0.1 to 10 bars. A partly or completely hydrogenated structure NaZn₁₃ is then obtained. Routine tests give the possibility of determining the correlation between notably the composition of the alloy, the grain size of the powder, and the treatment conditions, which give the possibility of reaching a given hydrogenation degree which is expressed by the value of the parameter n in the chemical formula of the material.

If, instead of hydrogen, it is desired to introduce nitrogen into the composition of the material, nitridation may be carried out, after having heat-treated the powder as indicated, for example by maintaining the powder for 1 to 1,000 mins at a temperature of 400-1,100° C. in a nitrogen-containing atmosphere at a nitrogen partial pressure from 0.3 to 30 bars. Like for hydridation, the routine tests allow determination of the correlation between notably the composition of the alloy, the grain size of the powder and the treatment conditions which give the possibility of reaching a given nitridation degree which is expressed by the value of the parameter n in the chemical formula of the material.

Introduction of a portion or the totality of the C, if the intention is to insert it into the phase of the NaZn₁₃ type of the final alloy, may also be achieved at this stage by a conventional method for carbidation or carbonitridation of the powder.

If at this stage, it is desired to add several of the elements H, N and C, together or successively, this is therefore possible by using conventional techniques falling under the usual expertise of one skilled in the art, and easy to adapt by routine tests, to the particular case of the powders used in the invention.

The shaping of the powder is then achieved so as to make it a magnetocaloric element which may be used in a refrigerating machine.

Thus, according to the invention, the material prepared as earlier, is dispersed in a matrix formed by one or several organic components. This method is economical, avoids resorting to costly sintering both in time and in energy, and ensures good chemical and mechanical stability to the element.

It should be understood that the term of “matrix” as used within the context of the invention, does not prejudge the relative proportions of the magnetocaloric powder and of the organic material(s) used. The matrix is simply to be considered as the material which maintains the cohesion of the element, the powder of which is the active constituent.

The organic matrix further protects the magnetocaloric powder against corrosion. Further, it should be recalled that during the cooling of the magnetocaloric element of NaZn₁₃ structure or the application of the magnetic field to said element, the latter passes from the paramagnetic state to a ferromagnetic state, which is accompanied by a change in volume which may range up to about 1.35%, depending on the temperature, on the composition of the powder and on the intensity of the applied field. This expansion leads to a reduction of T_{C} during cooling, while during the reverse passing from the ferromagnetic state to the paramagnetic state, such constraints do not exist and T_{C} remains at its intrinsic value taking into account the composition of the powder. This in a dense material would cause an increase in the thermal hysteresis and the formation of cracks, because of the strength opposing the expansion of the material during the cycles of use of the element. The use of an elastic organic matrix allows absorption of these stresses by avoiding the cracking of the element, while retaining the positive effects of the expansion of the metal particles on the magnetocaloric performances.

In order to form the matrix, one or several organic binders intended to be mixed with the powder are selected. The selection of these binders is based on the following characteristics:
their capability of accepting a large volume of magnetocaloric powder, since the magnetocaloric properties of an element having a given volume are directly related to the volume proportion of magnetocaloric powder which it contains, relatively to the matrix;
their capability of being shaped at temperatures not affecting the magnetocaloric material;
their physical and chemical properties which should give them good resistance to the temperatures to which they are subject during the manufacturing and the use of the element, to the chemical etchings by the environment of the element, and compatibility with the magnetocaloric powder, notably from the point of view of their mechanical properties so as to actually obtain the absorption of the expansion stresses of the powder, which have been discussed.

As an example of such binders, mention may be made of a polymer selected from polyethylene, ethylene vinyl acetate, polypropylene, polystyrene, polycarbonate, epoxy resins, polyurethane resins.

A mixture of two binders or more may be used.

The volume proportion of magnetocaloric powder in the powder/binder mixture is typically from 40 to 80%. The lower limit of 40% is desired in order to guarantee a sufficient magnetocaloric effect for a given element volume. The upper limit of 80% is selected so as not to exaggeratedly load the element with powder, since the matrix would certainly not support this.

The use of atomized magnetocaloric particles proved to be advantageous as compared with particles which for example would derive from a solidified and then milled strip. Indeed, they give the possibility of having very good homogenization of the powder/binder(s) mixture, with a viscosity of a mixture compatible with the shaping method by compression, injection or extrusion, even for mixtures highly loaded with magnetocaloric particles. This is due to the substantially spherical shape of the particles obtained by atomization, which therefore provides a strong apparent density to the mixture while allowing maximization of its content in magnetocaloric particles. Also, the spherical shape provides low inter-particle friction processes, favorable to proper flow of the mixture during the shaping with the methods mentioned earlier. Finally, these particles have a good surface cleanliness, which makes reproducible their interactions with the binder(s).

The mixture may for example be shaped in or through a mold equipped with slots with a width from 0.2 to 2 mm, providing to the active portions of the element, their targeted thickness, which may therefore be locally remarkably small, or greater thickness which may be reduced by subsequent shaping operations. Pressing, injection or extrusion is carried out between 20 and 300° C., at pressures comprised between 1.5 MPa and 3,000 MPa. After the pressed mixture has come out of the mold or of the extrusion die, if the matrix is not already solidified, solidification of the matrix is carried out by heating between 20 and 300° C. and/or by projecting UV radiations, if the nature of the organic components used requires this in order to obtain the definitive properties of the matrix.

According to the invention, one begins by preparing an alloy powder of composition:

La₁₋ₓ(Ce,Pr)ₓ((Fe_{1-z-v}Mn_{z}Coᵥ)_{1-y}Si_{y})_{w}Xₙ

wherein:
X is one or several elements selected from C, N or B, it being understood that if in the final alloy X has to be partly or totally formed by H, this element (as well as possibly a portion or the totality of C and N), will be subsequently added via a gas route;
x=0 to 0.5 (it being understood that the presence of rare earths other than La, Ce and Pr at impurity contents cannot be excluded, the raw materials allowing the introduction of La, Ce and Pr into the alloy may contain up to 4% by weight, better up to 2% by weight, of other rare earths); preferably x=0.25 to 0.5;
y=0.05 to 0.2;
z=0 to 0.15;
v=0 to 0.15;
w=12 to 16;
n=0 to 3.5.

For this purpose, according to a preferential method, massive pieces of raw materials containing La, Ce and/or Pr (if they are present in the alloy to be obtained), Fe, Si, Mn (if it is present in the alloy to be obtained), Co (if it is present in the alloy to be obtained), or even also B and/or possibly the totality or a portion of the C if these elements have to be present in the alloy to be obtained in addition to or instead of H or N, are melted in an induction oven. During this melting operation, it should be taken into account that a portion of the La, Ce and Pr, which are strongly reducing elements, may react with the refractories of the furnace. It may therefore be recommended in practice that they be slightly introduced in excess for compensating for the predictable losses which may be determined by the experience of the metallurgist, who is aware of the usual operating conditions of the furnace used. The other elements are added in a pure form, or from ferro-alloys, scrap iron, or a mixture of such raw materials.

The step for fast solidification of the thereby prepared liquid alloy is carried out, for the reasons which have been discussed, by atomization of the gas of a metal jet, on an installation such as the one schematized in FIG. 1 and which has already been described in more detail. Its design per se is not original. Substantially spherical droplets of liquid metal are thereby obtained, which rapidly solidify in order to form a powder and are collected in the lower portion 13 of the atomization tower 12.

The particles 14 visible on the secondary electron image of the powder A shown in FIG. 2 are quasi-spherical and with an average diameter comprised between 10 and 100 μm. FIG. 3 shows backscattered electron images of the material of composition A after atomization and in FIG. 4, after it has been cast into an ingot mold (according to an operating method non-compliant with the invention), respectively magnified 600 and 500 times.

This powder A, in the illustrated example, has the composition in weight %:

Fe: 76.7%; La: 15.8%; Si: 4.67%; Co: 2.82%; C: 0.035% (impurity); N: 0.035% (impurity); O: 0.005% (impurity), i.e. a global atomic composition La(Fe_{0.86}Co_{0.03}Si_{0.11})_{13.8}.

In FIGS. 3 and 4 it is seen that the material after solidification consists of two phases:
a brilliant phase 15 rich in La: mainly La(Fe,Co)Si (a ternary defined compound LaFeSi partly substituted with Co);
and a dark phase 16: Fe(Co,Si) (a ferrite).

The effect of atomization, in terms of limitation of the segregation, is obvious. Phases are obtained with average dimensions of about 5 μm after atomization (FIG. 3) while they measure between 50 and 100 μm in an ingot obtained according to a conventional method (FIG. 4). The formation of the phase of type NaZn₁₃, at the interface of both of these phases, is then considerably facilitated.

After this first atomization step, heat-treatment is applied to the powder in order to form the magnetocaloric phase.

The inventors have discovered that both relevant phases were transformed into a phase with a structure of the NaZn₁₃ type by a transformation of the peritectic or peritectoic type, if the powder is heated under adequate conditions, for example for 5 mins at 8 hours between 1,080 and 1,150° C. Generally, the temperature for heating the powder should be comprised between 900 and 1,200° C., preferably between 1,000 and 1,200° C. so that the transformation may occur. The optimum duration of the heating depends on the operating conditions, which govern the kinetics of the transformation.

FIG. 5 shows x-ray diffraction spectra obtained on a powder B which is only atomized (curve 17) and then annealed for a duration set to 8 hours, at 1,000° C. (curve 18), 1,050° C. (curve 19), 1,120° C. (curve 20), and 1,170° C. (curve 21). In abscissas, appears the diffraction angle of 2θ at which the peaks appear, and in ordinates, qualitatively appears the intensity of the diffraction peaks.

The composition of this powder B is the following (in weight percentages):

Fe: 79.1%; La: 11.1%; Ce: 5.1%; Si: 4.4%; C: 0.0067% (impurity); N: 0.0045% (impurity); O: 0.03% (impurity), i.e. a global atomic composition La_{0.69}Ce_{0.31}(Fe_{0.9}Si_{0.1})_{13.6}.

The atomized powder in majority consists of the phase of the NaZn₁₃ type La_{0.7}Ce_{0.3}(Fe_{0.9}Si_{0.1})₁₃ after annealing between 1,000° C. and 1,170° C. However, the phase (La,Ce)FeSi persists up to 1,050° C. (9% by weight according to a refinement of the Rietveld type performed on the x-ray diffractograms, the method of which is described in the publication, H. M. Rietveld, J. Appl. Cryst. 2 (1969), 65, which allows calculation of the mass proportions of the various phases in a material). It is very important to remove this phase as far as possible, since it mobilizes a portion of the total of the rare earths introduced into the material, which will induce a smaller amount of phase of the NaZn₁₃ type.

Experiments have also been carried out on powders C and D with the respective compositions (in weight percentages): Fe: 76.9%; La: 15.8%; Si: 4.32%; Co: 2.74%; C: 0.045% (impurity); N: 0.043% (impurity); O: 0.006% (impurity), i.e. a global atomic composition La(Fe_{0.86}Co_{0.03}Si_{0.11})_{13.8} and Fe: 80.8%; La: 14.6%; Si: 4.39%; Co: 0.04% (impurity); C: 0.046% (impurity); N: 0.064% (impurity); O: 0.012% (impurity), i.e. a global atomic composition La(Fe_{0.90}Si_{0.10})_{15.1}.

FIG. 6 shows the time-dependent change in the mass proportions of phases of the NaZn₁₃ type (curve 22 for powder C, curve 23 for powder D), a ferrite type (curve 24 for powder C, curve 25 for powder D) and of the LaFeSi type or La(Fe,Co)Si type (curve 26 for powder C, curve 27 for powder D) in the powders C and D, versus the annealing temperature Tₐₙₙₑₐₗ. The latter is optimum for annealing temperatures between 1,080 and 1,150° C. Beyond, the efficiency of the annealing decreases because of the occurrence of a liquid phase containing the rare earths, at these temperatures. Beyond 1,200° C., this effect is frankly too large for the annealing to be sufficiently efficient, and this situation should therefore be avoided.

The inventors have also shown that the duration of the annealing of these powders between 5 mins and 8 hours has little influence on the mass proportions of the phases, provided that the temperature raising rate is not too fast. FIG. 7 shows x-ray diffraction spectra obtained on the atomized powder C and annealed at the temperature of 1,120° C. for durations of 5 mins (curve 28), 30 mins (curve 29) and 8 hours (curve 30). These annealings give the possibility of totally removing the phase La(Fe,Co)Si and of obtaining similar proportions of phase of the NaZn₁₃ type and of ferrite Fe(Si) (96% by weight of phase of the NaZn₁₃ type and 4% by weight of a ferrite on average).

Finally, under the tested conditions and regardless of the tested powder treated according to the invention, it is possible to obtain a powder containing at least 85% by weight of a phase of the NaZn₁₃ type. Generally, it is considered that within the scope of the invention, at least 70% of a structure of the NaZn₁₃ type should be obtained in the alloy.

The optimum annealing conditions as described earlier were validated in an industrial oven operating with powder batches of 8 to 10 kg, with, as main criteria, the proportion of phase of the NaZn₁₃ type formed as well as the homogeneity of the annealed powder.

Other fast solidification methods, such as wheel quenching, allow a strong reduction in the duration of the annealing for forming the phase of the NaZn₁₃ type. However, it is necessary to add a step for milling metal strips in order to be able to obtain blocks with diverse shapes before shaping. Further, the flake-shape of particles derived from milled metal strips strongly reduces the selection of shaping methods. These methods therefore do not fall under the invention.

In order to avoid oxidation of the powder, the heat-treatment should be carried out with inert gas sweeping, which also has the advantage of discharging the undesirable compounds adsorbed at the surface of the particles and potentially formed at a high temperature. Preferably, a step for desorption of humidity at 100-500° C. under an inert gas or in vacuo is carried out before the heat-treatment for the transformation as described earlier.

The materials of the La(Fe₁₋ₓSiₓ)₁₃ type have good magnetocaloric properties, but they have a limited maximum Curie temperature and clearly below the minimum limit of the targeted temperature range (which is from −30° C. to +50° C.). For example, the powder D annealed at 1,120° C., containing a phase of the NaZn₁₃ type of formula La(Fe_{0.9}Si_{0.1})₁₃, has a T_{C} of −73° C. and a change in magnetic entropy −ΔSₘ of 9.3 J/kg·K for a magnetic field of 1T. For constant (Fe+Mn+Co+Si)(La+Ce+Pr), Si(Fe+Mn+Co+Si), Mn(Fe+Mn+Co+Si) and/or Co(Fe+Mn+Co+Si) ratios, the introduction of Ce and/or Pr as a substitution for La, directed to improving the magnetocaloric properties of the material, will also decrease their T_{C}.

It is therefore necessary to apply one of the means for increasing T_{C} described in the present invention.

It is thus possible to proceed with the substitution of Fe with Co in the structure of the NaZn₁₃ type or with the insertion of lightweight elements into the atomic lattice cell, such as H, N, C or B in order to increase the T_{C} of the material. For inserting H, N and C, it is possible to carry out a second heat-treatment, generally at a temperature from 100 to 500° C., in an atmosphere of pure hydrogen, pure nitrogen or a mixture of one of these two gases with argon, under a pressure from 0.05 to 5 MPa for 1 min to 2 hours.

Carbon may be inserted via a solid route as soon as the melting, in a small amount, and via a gas route in larger proportions during the second heat-treatment.

The inventors have shown, as this is seen in FIG. 8, that the insertion of hydrogen into the lattice cell of the NaZn₁₃ type does not mandatorily require the use of high hydrogen pressures but that it may be carried out at atmospheric pressure under a simple flow of hydrogen and with the heating to moderate temperatures. The shift towards the low angles (expressing the insertion of hydrogen) is identical between the atomized, annealed, hydrogen-free powder D (curve 31) and the atomized, annealed and hydrogenated powders D under hydrogen flow at atmospheric pressure at 300° C. for 8 hours (curve 32), under the hydrogen flow at an atmospheric pressure at 400° C. for 1 hour (curve 33) and under a hydrogen pressure of more than 5 bars (unknown temperature? but probably 200° C.) (curve 34).

FIG. 9 shows the influence of the substitution of Fe with Co on the Curie temperature and the change in magnetic entropy of the atomized and annealed powders in the non-hydrided state D (curves 35 and 36), C (curves 37 and 38), E (with a weight composition of: Fe: 69.8%; La: 15.4%; Si: 4.4%; Co: 6.1% (impurity); N: 0.0084% (impurity); O: 0.043% (impurity), i.e. a global atomic composition La(Fe_{0.82}Co_{0.08}Si_{0.10})_{13.5}) (curves 39 and 40) and of atomized, annealed and hydrogenated powder D (curves 41 and 42). The magnetic entropies were calculated at 1T and 2T, from measurements of M(H) in a magnetic field varying from 0 to 2T. The observed increase in T_{C} (+17.3° C./mass % of Co) is accompanied by a decrease in |ΔSₘ| (−1.1 J/kg·K/mass % of Co)

Conversely, the insertion of H produced by heating the material at atmospheric pressure, under a flow of H₂ at 300° C. for 8 hours, degrades, very little, the magnetocaloric properties, and allows a very high increase in T_{C} (δ|ΔSₘ|=−3.7 J/kg·K for δ T_{C}=+130 K, for 0.2% by mass, H₂ with total hydridation). Selecting insertion of hydrogen into the lattice then clearly appears as the means to be preferred for increasing the T_{C} of the materials over a wide range of temperatures. Substitution of Fe with Co will optionally be a means of adjusting Tc, over small ranges of temperature, in order not to degrade the properties too much.

FIG. 10 shows the influence of the substitution of Fe with Mn on the Curie temperature and the variation of magnetic entropy of the powders B (curves 43, 44), F (with a weight composition of: Fe: 78.4%; La: 11.6%; Ce: 5.2%; Si: 4.24%; Mn: 0.364%; C: 0.0071% (impurity); N: 0.0083% (impurity); O: 0.018% (impurity), i.e. a global atomic composition La_{0.69}Ce_{0.31}(Fe_{0.899}Mn_{0.004}Si_{0.97})_{12.9}) (curves 45, 46), G (with a weight composition of: Fe: 75.6%; La: 12.0%; Ce: 5.3%; Si: 4.48%; Mn: 1.69%; C: 0.087% (impurity); N: 0.0054% (impurity); O: 0.037% (impurity), i.e. a global atomic composition La_{0.7}Ce_{0.3}(Fe_{0.877}Mn_{0.020}Si_{0.0103})_{12.4}) (curves 47, 48) and H (with a weight composition of: Fe: 74.1%; La: 12.1%; Ce: 5.3%; Si: 5.35%; Mn: 2.35%; C: 0.09% (impurity); N: 0.0035% (impurity); O: 0.022% (impurity), i.e. a global atomic composition La_{0.7}Ce_{0.3}(Fe_{0.851}Mn_{0.027}Si_{0.122})_{12.4}) (curves 49, 50) atomized, annealed and hydrogenated to a maximum. The magnetic entropies were calculated at 1T and 2T, from measurements of M(H) in a magnetic field varying from 0 to 2T. A decrease in T_{C} is observed (−28.8 K/mass % of Mn) which is faster than was its increase with Co and also a greater decrease in |ΔSₘ| (−7.6 J/kg·K/mass % of Mn). The use of the substitution of Mn for Fe for reducing T_{C} should only be used as an adjustment over narrow temperature ranges.

It is important to note that the materials described above were not synthesized under laboratory conditions (a few tens of grams) but under industrial conditions, on installations giving the possibility of achieving atomization of metal batches of 35 kg.

Both families of La(Fe,Co,Si)₁₃ (or La(Fe,Co,Si)₁₃Hₓ) and (La,Ce)(Fe,Mn,Si)₁₃Hₓ) materials give the possibility of covering the targeted temperature range, from 240 to 320 K (−30 to 50° C.). Comparison of FIGS. 9 and 10 also shows that although it degrades more rapidly with the Mn content, the |ΔSₘ| of the (La,Ce)(Fe,Mn,Si)₁₃Hₘₐₓ materials is greater than that of the La(Fe,Co,Si)₁₃ materials in the targeted temperature range. If T_{C} of the materials has to be decreased beyond a certain acceptable limit for Mn in the material, it is possible to decrease the hydrogen content with a partial dehydrogenation step of the material.

FIG. 11 shows the controlled decrease of T_{C} of the atomized, annealed and totally hydrogenated powder D over a temperature range of about 60° C. (between 0 and 60° C.). Treatments under an Ar flow, at a moderate temperature (between 150 and 250° C.) allow selective adjustment of T_{C} of the powders while limiting the degradation of |ΔSₘ| as shows the comparison between the curves 37, 38 and 41, 42 of FIG. 9, illustrating the atomized and annealed powder C, before and after maximum hydrogenation. The curve of FIG. 12, associated with curve 11 shows for the same powders treated under the indicated conditions, the variation of the lattice parameter a of the phase of the NaZn₁₃ type, La(Fe_{0.9}Si_{0.1})₁₃Hₓ. Each of the powders after treatment actually only includes a single phase which may be indexed with the parameters of the phase of the NaZn₁₃ type; this shows that partial dehydrogenation of the powders under an Ar flow between 150 and 250° C. is actually homogenous in the treated powder batch.

Once the composition of the material is adjusted according to the targeted T_{C} (it being understood that the composition is located in a range where |ΔSₘ| expresses good magnetocaloric performances), shaping of the element is achieved from the heat-treated powder (so called “activated powder”), containing at least 70% by weight of the phase of a structure of the NaZn₁₃ type, in order to conform it into a part intended to be used as a heat exchanger.

The activated powder is, for this purpose, mixed with one or several organic binders intended to form the matrix and preferably selected, as this is explained above, for obtaining an activated powder proportion comprised between 40 and 80% by volume of the material. Next the mixture is milled or granulated. The shaping of the mixture is then carried out by one of the methods mentioned earlier.

In the case of shaping carried out by pressing or injection into a mold, or by extrusion through a die, it is carried out preferably between 20 and 300° C., according, in particular, to the nature of the matrix, and may be followed, after removal from the mold, by baking at a temperature adapted to the nature of the matrix, for example from 20 to 300° C. and/or by UV irradiation.

If it is desired to widen the range of effective temperatures of the magnetocaloric element, this may be achieved by mixing two different powders or more, each having a different Tc, this difference may range up to 80° C. between the highest T_{C} and the lowest T_{C}.

In a first example, 35 kg of an alloy according to the invention were melted in a closed induction furnace 2 in a sealed chamber 1 inertized with argon with slight overpressure (up to 0.5 bars) relatively to atmospheric pressure. The target was to obtain an alloy of composition La_{0.75}Ce_{0.25}(Fe_{0.9}Si_{0.1})₁₃. For this purpose, a batch was used including 13.6% by weight of La and 4.6% of Ce (i.e. 10% of La and Ce more than what was theoretically necessary, in order to compensate for the losses during the elaboration), 77.5% by weight of Fe, and 4.3% by weight of Si. The liquid metal 4 was then poured into a distributor 5 also contained in the chamber 1, and it flowed out of the distributor 5 through an orifice 7 of a nozzle 6 with a diameter of 6 mm. At its outlet of the orifice, the liquid metal jet 8 was atomized with argon flowing out of nozzles 9, 10 at a pressure of 50 bars before its outflow. A magnetocaloric powder of an alloy was thus obtained, having the following characteristics:
composition in weight %: Fe: 78.1%; La: 12.2%; Ce: 4.6%; Si: 4.3%; with a global atomic composition La_{0.73}Ce_{0.27}(Fe_{0.9}Si_{0.1})_{12.9}
diameter of the particles D50: 75 μm.

This powder was then annealed at 1,120° C., for 8 hours under an inert atmosphere. At the end of this treatment, the powder had about 88% by mass of magnetocaloric phase (according to x-ray diffraction measurements), a T_{C} of 168 K and a value of |ΔSₘ| of about 18 J/kg·K for a magnetic field variation of 1T. This powder was then hydrogenated under a flow of hydrogen at about 400° C. in order to attain a T_{C} of 330 K (57° C.) for a |ΔSₘ| of about 14.8 J/kg·K for a magnetic field variation of 1T. It was finally dehydrogenated in a controlled way in order to form several homogenous batches with T_{C} equal to 27, 18 and 15° C. Finally, the powder at 15° C. was mixed with low density polyethylene (LDPE) and then granulated. The granules obtained by this method have a final T_{C} of 15° C. and a |ΔSₘ| of about 5.3 J/kg·K.

In another complete example for making consolidated parts, a powder (La,Ce)(Fe,Mn,Si)₁₃Hₓ (powder G) atomized and heat-treated according to the method of the invention, was shaped by extrusion of a metal batch according to the process below. This powder had the following characteristics:
a global atomic composition: La_{0.7}Ce_{0.3}(Fe_{0.877}Mn_{0.020}Si_{0.103})_{12.4}
a magnetocaloric phase proportion after annealing and hydrogenation: 94% by mass.
a diameter of the particles D50: 38.4 μm;
a packed density: 3.65 g/cm³

Into a blade mixer of the Gericke type, are introduced polyethylene LDPE as a powder and the metal powder. The selected polyethylene has the following characteristics: fluid index MFR=22 dg/min (190° C./2.16 kg), density=919 k/gm³. The mixing is achieved at room temperature, with a speed of rotation of 25 rpm for 10 mins. The proportions of the mixture are the following: polyethylene 36% by volume, metal powder 64% by volume for a total mixed weight of 5 kg.

In a co-rotating twin screw extruder of the TSA brand (screw diameter of 20 mm, length 1,000 mm), heated up to 160° C. at the extruder head, the mixture obtained earlier is introduced thereto. The speed of rotation of the screws was set to 40 rpm. The powder and the polymer intimately mix under the combined action of the heat and of the shearing imposed by the co-rotating screws. At the outlet, the mixture is extruded through a cylindrical die in order to obtain a ring. With this adjustment, a constant flow rate of 4.5 kg/h of material is obtained at the outlet of the extruder.

The obtained rings are milled in a mechanical milling machine equipped with a grid of 2 mm. The thereby obtained granules may be transformed in a standard single-screw extruder.

In a second step, the material is shaped as a thin plate. To do this, an extrusion line is used, consisting of a single screw extruder of the Greiner type (screw diameter of 30 mm, length 762 mm), equipped at its output with a shaping die. Coupled with the die, are found a conformer which guarantees the maintaining of the shape and then an immersion pan in vacuo for the cooling. Finally, at the outlet of the immersion pan, a drying and maintaining tool is used, and then the profile is drawn by means of a drawer.

The single screw extruder was adjusted according to the following parameters: heat profile with a temperature at the extruder head of 165° C., speed of rotation set to 15 rpm and temperature of the conformer of 80° C. With this adjustment, an outlet speed of the profile of 4 m/min was obtained.

The final obtained product, shown in FIGS. 13 and 14, is a strip with a thickness of 0.6 mm and of great length. It consists of 64% by volume of magnetocaloric powder dispersed in a polymeric matrix.

1. A method for manufacturing a magnetocaloric element comprising
La₁₋ₓ(Ce,Pr)ₓ((Fe_{1-z-v}Mn_{z}Coᵥ)_{1-y}Si_{y})_{w}Xₙ
, wherein
X is one or several elements selected from the group consisting of H, C, N and B;
x=0 to 0.5;
y=0.05 to 0.2;
z=0 to 0.15;
v=0 to 0.15;
w=12 to 16;
n=0 to 3.5;
the method comprising:
elaborating a liquid alloy in a crucible;
solidifying said liquid alloy in the form of a powder of substantially spherical particles with an average diameter comprised between 10 and 100 μm by atomization of a jet of said liquid alloy with an inert gas;
optionally, heat-treating said powder at a temperature comprised between 100 and 500° C. for at least 1 min in a non-oxidizing atmosphere to remove compounds adsorbed by the powder;
heat-treating of said powder to give it, at least at 70% by weight, a phase with a structure of the Na_{Z}n₁₃ type by heating under an inert or reducing atmosphere or in vacuo up to a temperature from 900 to 1,200° C.;
optionally, hybridizing and/or nitriding and/or carbidating and/or carbonitriding said powder to give n its definitive value;
dispersing said powder in a matrix formed by one or several organic binders to form a mixture comprising 40 to 80% by volume of powder;
shaping said mixture; and
optionally solidifying the matrix,
wherein said magnetocaloric element comprises a maximum content of 4% by weight of rare earths other than La, Ce and Pr, and a maximum content of 2% by weight, of other impurities.

2. The method according to claim 1, wherein the heat treatment of the powder giving it a structure of the Na_{z}n₁₃ type comprises a step of heating the powder at a rate of 1 to 200° C./min up to the treatment temperature.

3. The method according to claim 1, wherein the solidification of the matrix is carried out by heating between 20 and 300° C. and/or by projecting UV radiation.

4. The method according to claim 1, wherein, before shaping, the mixture formed by the powder and the binders is milled and granulated.

5. The method according to claim 1, wherein at least two different powders for which the higher and lower Curie temperatures differ by at most 80° C. are mixed with the matrix.

6. The method according to claim 1, wherein the binder comprises at least one polymer selected from the group consisting of polyethylene, ethylene vinyl acetate, polypropylene, polystyrene, polycarbonate, an epoxy resin, and a polyurethane resin.

7. The method according to claim 1, wherein the shaping of the mixture is achieved by transformation under a pressure from 1.5 to 3,000 MPa at a temperature from 20 to 300° C.

8. The method according to claim 1, wherein the shaping of the mixture is achieved by compression in a mold.

9. The method according to claim 1, wherein the shaping of the mixture is achieved by injection in a mold.

10. The method according to claim 1, wherein the shaping of the mixture is achieved by extrusion.

11. A magnetocaloric element obtained by the method according to claim 1.

12. The magnetocaloric element according to claim 11, wherein its thickness is at least locally comprised between 0.2 and 2 mm.

13. The method of claim 1, wherein said magnetocaloric element comprises a maximum content of 2% by weight of rare earths other than La, Ce and Pr.

14. The method of claim 1, wherein said heat-treating of said powder to give the powder, at least at 70% by weight, a phase with a structure of the Na_{Z}n₁₃ type by heating under an inert or reducing atmosphere or in vacuo is at a temperature of from 1,000 to 1,200° C.
